(19) United States
(12) Patent Application Publication
(10) Pub. No.: US 2010/0237090 A1
(43) Pub. Date: Sep. 23, 2010

(54) PACIFIER DISPENSER AND METHOD

(76) Inventor: Paul C. Klehr, Arlington Heights, IL (US)

Correspondence Address: Anne MCGOVERN BURKHART, 701 Maple Ave., Downers Grove, IL, 60515, US

(21) Appl. No.: 12/383,138

(22) Filed: Mar. 20, 2009

(51) Int. Cl. B65D 83/00; B65G 59/00

(52) U.S. Cl. 221/199; 221/282; 221/283; 221/1

(57) ABSTRACT

A pacifier dispenser for pacifiers has a nipple portion, a flange portion, and a handle. The dispenser includes a body portion of sufficient size to hold a plurality of pacifiers. A longitudinal nipple slot is adapted and constructed to hold the nipple portions of pacifiers in the holder. A main chamber is adapted and constructed to retain the flange portion of the pacifier, and a longitudinal slot adapted and constructed to allow the handles of the pacifiers to extend outside of the dispenser. A user grasps the handle portion of a pacifier in the dispenser to remove the pacifier therefrom.

### CROSS-REFERENCE TO RELATED APPLICATION

None.

### BACKGROUND OF THE INVENTION

The use of fabricated devices for soothing human infants predates recorded history. Archeologists have discovered clay animal figures having handles and a single large opening, presumed to be for sucking a thick material like honey out of the object, in graves dated 2,000 to 3,000 years ago. Similar objects are known to have been made in Europe until the Middle Ages. For example, a painting of the Madonna and Child created in 1506 by Albrecht Durer shows a “rag bag,” which was used throughout Europe and in Russia. Strips of rag were knotted around foods like bread, grain, meat, or fat. These bags were typically moistened with liquids like milk, brandy or laudanum (an opium and alcohol mixture), or contained poppy seeds (from which opium is made).

Teething aids were produced to ease the pain of sore gums. Many of these were made from the bones of animals, or from ivory, or from red coral. Candles, licorice sticks, carrots and of course, crisp bread crusts have all been used. Wealthy mothers eventually used silver spoons for this purpose, giving rise to the famous phrase, “born with a silver spoon in his mouth”.

When rubber was developed in the 19th century, the pacifier as we know it today was born. Early pacifiers were without the safety flange, and posed a higher risk of choking. One early model contained a not insignificant amount of lead. Today, pacifiers are available in many shapes and colors, with many different cartoon characters emblazoned on them.

Pacifier holders and dispensers therefore have been the subject of a high degree of inventive activity, as evidenced by the patent literature. For example, U.S. Pat. No. 5,593,336 is directed to pacifier holder for holding a pacifier on its upper surface for easy use by an infant. This pacifier holder consists of a soft lightweight elongated generally tubular member that loosely holds a pacifier on its first or upper end region. The holder is configured such that this first end region is offset by curvature from the remainder of the holder so as to position the pacifier in front of the infant's mouth when in use as the remainder of the elongated holder is placed upon the infant's chest. During use, the holder, being placed on top of the infant, will be positioned such that the pacifier is within easy reach of the infant.

U.S. Pat. No. 5,722,537 shows a portable disinfectant container for an infant pacifier or infant nursing nipple, consisting of a half-oval shaped disinfectant container which is provided with a sponge that may be saturated with any appropriate non-toxic disinfectant solution. The disinfectant container is constructed of durable ABS plastic and has an attached hook for hanging on a purse, baby bag, stroller, or crib. The hinged lid of the disinfectant container may be flipped open and a pacifier or nipple inserted into a slit in the sponge for disinfectant purposes, the absorption qualities of the sponge preventing any type of spillage of the disinfectant.

U.S. Pat. No. 6,120,092 describes a holder for infant accessories such as pacifiers or the like is defined by a substantially cylindrical side wall and a circular bottom wall which are secured together by any suitable method, such as sewing or the like. The side wall and the bottom wall are formed from a soft pliant material, such as a natural fiber and may be defined by an outer layer of pliant material an intermediate layer of cushioning material and an inner layer of plaint material. Suitable belting sections are secured to the side wall to enable the holder to be removably attached to a slat of a crib or other infant seating device. The device enables the stowage and easy accessibility to infant accessories by both the infant and a caregiver.

U.S. Pat. No. 6,347,722 deals with an apparatus comprising a dispenser having a flanged tubular container removably engaged in a bracket. The container has an interior space for holding pacifiers and a flexible gasket at the bottom of the container to retain the pacifiers in the container. The pacifiers are placed in the container with the nipple facing downward. The body of the pacifier is held inside the container by the gasket. By grasping the pacifier at the side openings of the container and pulling downward, the gasket will deform and the pacifier will be released from the container. The gasket will return to its original shape and the next pacifier will be held until needed. The bracket may be fixedly mounted to a wall or it may be attached to a crib by a pair of Velcro straps.

U.S. Pat. No. 5,607,452 discloses a holder for retaining a pacifier in a baby crib in a position which is readily accessible to a child. The pacifier holder is preferably made of rubber material, and includes a mounting and a pacifier holder. The mounting mounts the pacifier holder to a vertical bar of a baby crib and is either a wrap around flap partly covered with VELCRO™ material, or a clip-on tubular member. In both embodiments a friction of the rubber material against the crib bar retains the pacifier in place on the bar. Furthermore, the mounting of both embodiments is adaptable to crib bars of different sizes and shapes. The pacifier holder includes a flexible upper finger and a flexible lower finger, defining a holding slot for retaining a pacifier therein. The upper finger is optionally curved upwardly in the shape of a hook for retaining a variety of baby articles.

### SUMMARY OF THE INVENTION

A pacifier dispenser for pacifiers has a nipple portion, a flange portion, and a handle. The dispenser includes a body portion of sufficient size to hold a plurality of pacifiers. A longitudinal nipple slot is adapted and constructed to hold the nipple portions of pacifiers in the holder. A main chamber is adapted and constructed to retain the flange portion of the pacifier, and a longitudinal slot adapted and constructed to allow the handles of the pacifiers to extend outside of the dispenser. A user grasps the handle portion of a pacifier in the dispenser to remove the pacifier therefrom.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a perspective view of an embodiment of a pacifier dispenser in accordance with the principles of the present invention.

FIG. 2 illustrates a detailed bottom view of the FIG. 1 embodiment.

FIG. 3 illustrates a detailed rear view of the FIG. 1 embodiment.

FIG. 4 illustrates a front view of a package for the pacifier dispenser of FIG. 1.

### DETAILED DESCRIPTION OF THE INVENTION:

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows, will refer to the invention as depicted in the drawings.

An embodiment of a dispenser 10 in accordance with the principles of the present invention is shown in FIG. 1. The pacifier dispenser 10 can retain multiple pacifiers, here illustrated as pacifiers 12, 14, 16. Although the dispenser 10 can be designed to accommodate any pacifier, it is contemplated that a dispenser designed specifically for the SOOTHIE pacifier will be advantageous.

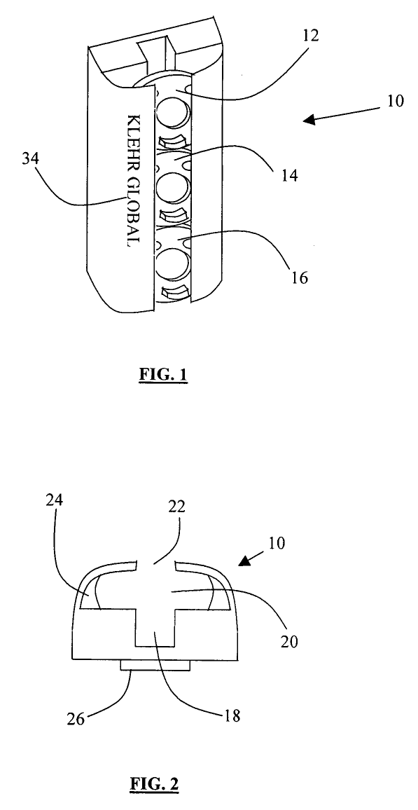

As shown in FIGS. 1 and 2, the dispenser 10 includes a longitudinal nipple slot 18 having a size and cross-section chosen to fit the nipple portions of the pacifiers 12, 14, 16. a main chamber 20 is provided to hold the flange portions of the pacifiers 12, 14, 16. A slot 22 allows the handles of the pacifiers 12, 14, 16 to extend out of the dispenser 10. A pair of flexible lips 24 are secured to the bottom of the dispenser to retain the pacifiers 12, 14, 16 therein.

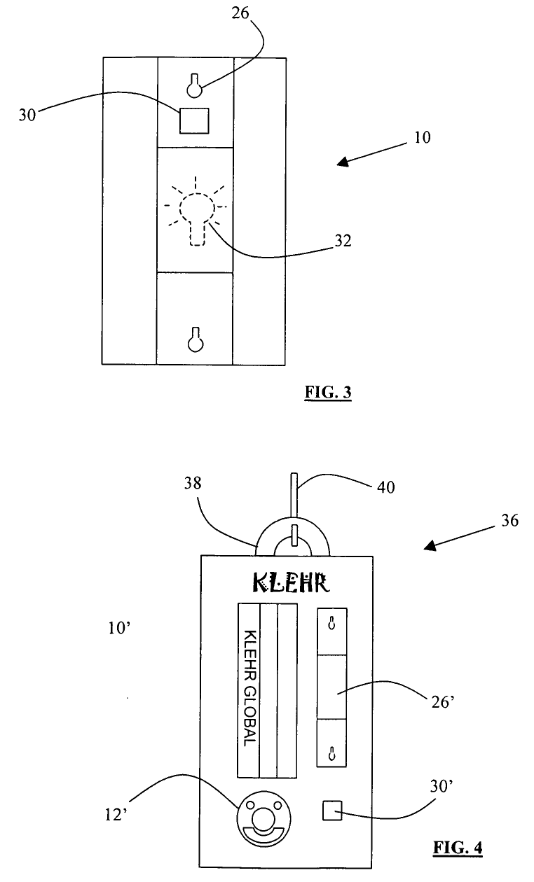

FIG. 3 illustrates a mounting portion 26 of the dispenser 10. The mounting portion 26 includes a plurality of mounting holes 28 and adhesive elements 30 to secure the mounting bracket to a surface. The mounting portion 26 can be secured to the body of the dispenser 10 via clips or other known attachment mechanisms. Alternatively, the mounting portion 26 can be molded integrally with the dispenser 10. An optional transparent covering over a night light 32 can be provided in the mounting portion 26, or in any suitable area of the dispenser 10. The night light 32 can be powered via an outlet plug or battery.

The dispenser 10 can be attached to a crib, bassinet, wall, or any surface in a baby's room or other convenient location. The dispenser 10 can be molded in or painted a suitable color, such as blue for boys, pink for girls, or a color associated with the particular pacifier to be dispensed, e.g., green for the SOOTHIE brand pacifier. Preferably, the dispenser 10 is formed of a dishwasher safe material.

As illustrated in FIG. 4, the dispenser 10′ can be sold in a package 36 including, for example, a single pacifier 12′. Pacifiers are often sold in two-packs. Advantageously, the inclusion of a single pacifier can both fill the dispenser, if the purchaser already owns a set, or accompany the purchase of a known packaged set.

The present invention also includes employing the pacifier dispenser 10 in a marketing method, in part using advertising indicia 34 as shown in FIG. 1. In a first example, hospitals, pediatricians, obstetricians, or other healthcare entities affix advertising indicia on the pacifier dispenser 10. The pacifier dispensers 10 are then distributed by the healthcare entity to new parents, either in the maternity ward of the hospital, or at the place of business of the healthcare entity. Alternatively, retailers market the pacifier dispenser 10 bearing their own advertising indicia and containing a plurality of pacifiers. The indicia can include information regarding ordering refill packs for the pacifier dispenser 10. In addition to advertising indicia for the distributor of the pacifier dispenser 10 and pacifiers, indicia identifying the pacifier manufacturer can also be affixed to the pacifier dispenser 10. This would allow the manufacturer to direct parents to the manufacturer's website for news and information regarding the pacifiers themselves.

With the pacifier dispenser 10 mounted in a prominent location, parents would have a constantly-present marketing tool prompting them to patronize the pacifier dispenser 10 distributor and/or the pacifier manufacturer. This presence will drive sales and clientele to the distributor and manufacturer.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim as my invention:

1. A pacifier dispenser for pacifiers having a nipple portion, a flange portion, and a handle, the dispenser comprising the following:
a body portion of sufficient size to hold a plurality of pacifiers;
a longitudinal nipple slot adapted and constructed to hold the nipple portions of pacifiers in the holder;
a main chamber adapted and constructed to retain the flange portion of the pacifier; and
a longitudinal slot adapted and constructed to allow the handles of the pacifiers to extend outside of the dispenser;
whereby a user grasps the handle portion of a pacifier in the dispenser to remove the pacifier therefrom.

2. A dispenser in accordance with claim 1, further comprising a mounting portion secured to the main body of the dispenser.

3. A dispenser in accordance with claim 2, wherein the mounting portion comprises at least one mounting slot.

4. A dispenser in accordance with claim 2, wherein the mounting portion comprises at least one adhesive mounting mechanism.

5. A dispenser in accordance with claim 2, wherein the mounting portion comprises at least one of a battery-powered night light and a plug in night light.

6. A dispenser in accordance with claim 1, wherein the dispenser is provided with indicia.

7. A dispenser in accordance with claim 6, wherein the dispenser is provided with advertising indicia.

8. A dispenser in accordance with claim 7, wherein the dispenser is provided with advertising indicia relating to a distributor of the dispenser.

9. A dispenser in accordance with claim 8, wherein the dispenser is provided with advertising indicia relating to a healthcare entity that is a distributor of the dispenser.

10. A dispenser in accordance with claim 8, wherein the dispenser is provided with advertising indicia relating to a retailer that is a distributor of the dispenser.

11. A dispenser in accordance with claim 8, wherein the dispenser is provided with advertising indicia relating to a distributor of the dispenser and to a manufacturer of the pacifiers dispensed.

12. A method for marketing to parents of infants, the method comprising the following steps:
providing a pacifier dispenser for pacifiers having a nipple portion, a flange portion, and a handle, the dispenser comprising a body portion of sufficient size to hold a plurality of pacifiers, a longitudinal nipple slot adapted and constructed to hold the nipple portions of pacifiers in the holder, a main chamber adapted and constructed to retain the flange portion of the pacifier, and a longitudinal slot adapted and constructed to allow the handles of the pacifiers to extend outside of the dispenser, whereby a user grasps the handle portion of a pacifier in the dispenser to remove the pacifier therefrom;
affixing advertising indicia to the body of the dispenser, the advertising indicia being directed to products or services used by parents of infants; and
distributing the dispensers to parents of infants.

13. A method in accordance with claim 12, Wherein the step of affixing advertising indicia comprises affixing advertising indicia relating to a distributor of the dispenser.

14. A method in accordance with claim 12, wherein the step of affixing advertising indicia comprises affixing advertising indicia relating to a healthcare entity that is a distributor of the dispenser.

15. A method in accordance with claim 12, wherein the step of affixing advertising indicia comprises affixing advertising indicia relating to a retailer that is a distributor of the dispenser.

16. A method in accordance with claim 12, wherein the step of affixing advertising indicia comprises affixing advertising indicia relating to a distributor of the dispenser and to a manufacturer of the pacifiers dispensed.

17. A method in accordance with claim 12, wherein the step of providing a dispenser further comprises providing a dispenser having a mounting portion secured to the main body of the dispenser.

18. A method in accordance with claim 12, wherein the step of providing a dispenser further comprises providing a dispenser having mounting portion including at least one mounting slot.

19. A method in accordance with claim 12, wherein the step of providing a dispenser further comprises providing a dispenser having a mounting portion including at least one adhesive mounting mechanism.

20. A method in accordance with claim 12, wherein the step of providing a dispenser further comprises providing a dispenser having a mounting portion comprising at least one of battery-powered night light and a plug in night light.
